(19) United States
(12) Patent Application Publication
(10) Pub. No.: US 2006/0041507 A1
(43) Pub. Date: Feb. 23, 2006

(54) Pluggable authentication for transaction tool management services

(75) Inventors: Brian M. Novack, St. Louis, MO (US); Daniel Larry Madsen, Castro Valley, CA (US); Michael David Cheaney, Arnold, MO (US); Timothy R. Thompson, St. Louis, MO (US); Andrea A. Wilemon, Livonia, MI (US)

Correspondence Address: GREENBLUM & BERNSTEIN, P.L.C., 1950 ROLAND CLARKE PLACE, RESTON, VA, 20191, US

(73) Assignee: SBC KNOWLEDGE VENTURES L.P., Austin, TX (US)

(21) Appl. No.: 10/917,415

(22) Filed: Aug. 13, 2004

(51) Int. Cl. G06Q 99/00

(52) U.S. Cl. 705/50

(57) ABSTRACT

A system is provided for managing a transaction tool for an individual. The system includes a receiver that receives a request from the individual to initiate a process for managing the transaction tool. A processor analyzes the request from the individual and dynamically selects, based upon the requested process, at least one authentication method to be used for authenticating the identity of the individual before the request can be honored. The selected authentication method(s) are used to verify the identity of the individual.

### BACKGROUND OF THE INVENTION

1. Field of the Invention

The present invention relates to authentication. More particularly, the present invention relates to risk-based user authentication for users attempting to initiate functions relating to the management and/or use of transaction tools in a communications network.

2. Background Information

A need exists to provide risk-based user authentication for users attempting to initiate management of transaction tools. Additionally, a need exists to provide risk-based user authentication for users attempting to initiate transactions using transaction tools.

Different types of transactions present different types of risks to the issuer and authorized user of a transaction tool. Transaction tools are instruments issued by a third party to facilitate transactions and/or information exchanges by “vouching” for a holder's identity and/or trustworthiness. Accordingly, transaction tools are themselves used to authenticate the identity or trustworthiness of a bearer. Therefore, the transaction tools must be carefully managed to ensure that they are not misused by impersonators or other unauthorized users.

Authentication of the identity of a user is typically one-dimensional and static, regardless of the risk posed in allowing the user to initiate a particular function relating to the management and/or use of transaction tools in a communications network. For example, an account number and password provided by the user may be used to verify authorization for the user to access a server that provides a web service over the internet. Alternatively, a user's home phone number and/or address, provided automatically when the user makes a call from a home phone, may be used to verify authorization for the user to access a credit card system that provides a service over the telecommunications network.

One-dimensional and static authentication processes subject transaction tools to misuse. For example, an imposter may be allowed to manage or use a transaction tool such as a credit card if a user's account number and/or password are appropriated. Additionally, an imposter may be allowed to manage or use a transaction tool such as a digital certificate if a user's communications device is appropriated. In other words, a transaction tool such as a digital certificate or credit card may be compromised when an impersonator overcomes the static one-dimensional authentication processes used by a system that allows users to initiate functions relating to transaction tools. Accordingly, static and one-dimensional authentication methods today do not adequately authenticate the identity of an authorized individual user in many cases; rather, existing authentication methods often only ensure that the user possesses the correct static and one-dimensional authentication information.

Accordingly, a need exists for risk-based user authentication for users attempting to initiate management of transaction tools. Additionally, a need exists to provide risk-based user authentication for users attempting to initiate transactions using transaction tools.

To solve the above-described problems, a system is provided for pluggable authentication for transaction tool management services.

### BRIEF DESCRIPTION OF THE DRAWINGS

The present invention is further described in the detailed description that follows, by reference to the noted drawings by way of non-limiting examples of embodiments of the present invention, in which like reference numerals represent similar parts throughout several views of the drawing, and in which:

FIG. 1 shows an exemplary communications network architecture for pluggable authentication for transaction tool management services, according to an aspect of the present invention;

FIG. 2 shows another exemplary communications network architecture for pluggable authentication for transaction tool management services, according to an aspect of the present invention;

FIG. 3 is an exemplary flow diagram showing a method of authenticating an individual with pluggable authentication for transaction tool management services, according to an aspect of the present invention; and

FIG. 4 is an exemplary flow diagram showing a method of operation for a transaction tool system that uses pluggable authentication for transaction tool management services, according to an aspect of the present invention.

### DETAILED DESCRIPTION OF THE INVENTION

In view of the foregoing, the present invention, through one or more of its various aspects, embodiments and/or specific features or sub-components, is thus intended to bring out one or more of the advantages as specifically noted below.

According to an aspect of the present invention, a system is provided for managing a transaction tool for an individual. The system includes a receiver that receives a request from the individual to initiate a process for managing the transaction tool. The system also includes a processor that analyzes the request from the individual and dynamically selects, based upon the requested process, at least one authentication method to be used for authenticating the identity of the individual before the request can be honored. The selected authentication method(s) are used to verify the identity of the individual.

According to another aspect of the present invention, the processor dynamically selects a plurality of authentication methods to be used.

According to yet another aspect of the present invention, the selection of authentication method(s) is also based upon a type of location from which the request is received and/or a type of communications mode used to make the request.

According to still another aspect of the present invention, the request is received over a network.

According to another aspect of the present invention, the requested process is a recovery, a revocation or an activation of a digital certificate.

According to yet another aspect of the present invention, the requested process is an activation or a cancellation of a credit account.

According to still another aspect of the present invention, the authentication method(s) include an authentication method performed by an external authentication service.

According to an aspect of the present invention, a method is provided for managing a transaction tool for an individual. The method includes receiving a request from the individual to initiate a process for managing the transaction tool. The method also includes analyzing the request from the individual and dynamically selecting, based upon the requested process, at least one authentication method to be used for authenticating the identity of the individual before the request can be honored. The method also includes verifying the identity of the individual using the selected authentication method(s).

According to another aspect of the present invention, the method includes dynamically selecting a plurality of authentication methods to be used.

According to yet another aspect of the present invention, the selection of authentication method(s) is also based upon at least a type of location from which the request is received and/or a type of communications mode used to make the request.

According to still another aspect of the present invention, the request is received over a network.

According to another aspect of the present invention, the requested process is a recovery, a revocation or an issuance of a digital certificate.

According to yet another aspect of the present invention, the requested process is an activation or a cancellation of a credit account.

According to still another aspect of the present invention, the authentication methods includes an authentication method performed by an external authentication service.

According to an aspect of the present invention, a computer readable medium is provided that stores a program that manages a transaction tool for an individual. The computer readable medium includes a request receiving code segment that receives a request from the individual to initiate a process for managing the transaction tool. The computer readable medium also includes an analyzing code segment that analyzes the request from the individual and dynamically selects, based upon the requested process, at least one authentication method to be used for authenticating the identity of the individual before the request can be honored. The computer readable medium also includes a verifying source code segment that verifies the identity of the individual using the selected authentication method(s).

According to another aspect of the present invention, the analyzing code segment dynamically selects multiple authentication methods to be used.

According to yet another aspect of the present invention, the analyzing code segment selects the authentication method(s) based upon at least a type of location from which the request is received and/or a type of communications mode used to make the request.

According to still another aspect of the present invention, the request receiving code segment receives the request over a network.

According to another aspect of the present invention, the request receiving code segment receives a request to initiate a process that includes a recovery, a revocation or an issuance of a digital certificate.

According to yet another aspect of the present invention, the request receiving code segment receives a request to initiate a process that includes an activation or a cancellation of a credit account.

According to still another aspect of the present invention, the authentication method(s) include an authentication method performed by an external authentication service

A communications system is provided for dynamic risk-based user authentication of users attempting to manage and/or use a transaction tool in a communications network. The communications system includes a communications device and a transaction tool system. As used in the present application, the user may be an individual, e.g., a customer, using a communications device to obtain access to a service supported by a transaction tool system. The transaction tool system may include a transaction tool server or any other type of communications apparatus that supports management and use of a transaction tool.

In an embodiment, the communications network is a packet-switching network, such as the internet. An individual communications device, such as an internet-enabled personal computer, personal digital assistant (PDA) or other device with a browser, is connected to a router that routes packetized data to a transaction tool system. In another embodiment, the communications network is a circuit-switched network, such as an advanced intelligent network (AIN). An individual communications device, such as a telephone or other audio-enabled device, is connected to a switch that provides a dedicated connection to the transaction tool system. In yet another embodiment, the communications network is a secure network, such as a private network or a virtual private network. Of course, the communications network is not limited to those noted above, but may be any type of network or combination of networks that act as a conduit for the exchange of information.

The transaction tool system is a dynamic management system for transaction tools. The transaction tool system allows users to dynamically manage and/or use transaction tools as desired. Pluggable authentication is provided for the transaction tool system so that the user can be authenticated as necessary before being allowed to initiate a function related to the management and/or use of a transaction tool managed by the transaction tool system. The authentication may include a consideration of numerous aspects of the circumstance related to a transaction or management request, such that authentication methods used for a single function may vary depending upon the purported identity of the user, the location of the user, the mode of communication used by the user, or any other circumstance that can be determined. Additionally, multiple authentication methods may be selected so that the verification of the identity of a user is dynamically adjusted for the risk presented by the request. Thus, in an embodiment of the present invention, a single type of request may not always result in the same authentication requirement. Therefore, in an embodiment of the present invention, a dynamic method of selecting authentication processes is used to adjust the required authentication based upon the risk presented by the circumstances of the request.

Of course, a given requested function may not require any authentication of the user's identification. For example, a user's identity does not need to be authenticated if the user is merely requesting introductory information from the transaction tool system. However, other requested functions may require a high-level of specific and personal authentication of the user's identification. For example, biometric authentication may be required before honoring a user's request to recover, revoke or issue a digital certificate. Still other requested functions may require only a standard authentication of the user's identification. For example, a simple account number and password combination may be all that is required for a user to use a credit card to make a small purchase. Of course, one or more functions may require multiple authentication methods for authenticating the user's identification.

Accordingly, when communications are received, the transaction tool system interacts with the user until the transaction tool system determines that the identity of the user must be established. The authentication system determines which authentication method(s) are required, and initiates the authentication procedures. The determination depends on particular risk factors, such as the requested function, the purported identity of the requester, the origin of the request, and/or the communications mode used by the originating device.

In an embodiment, the transaction tool system initiates a session with an external authentication system that can be used for high-level and/or centralized authentication. The transaction tool system determines which method(s) of authentication will be invoked, and requires the user to provide information as necessary. When the external authentication system is provided, the transaction tool system obtains the information from the user and forwards the information to the authentication system. Accordingly, the user may not be aware that an external authentication system is part of the authentication process.

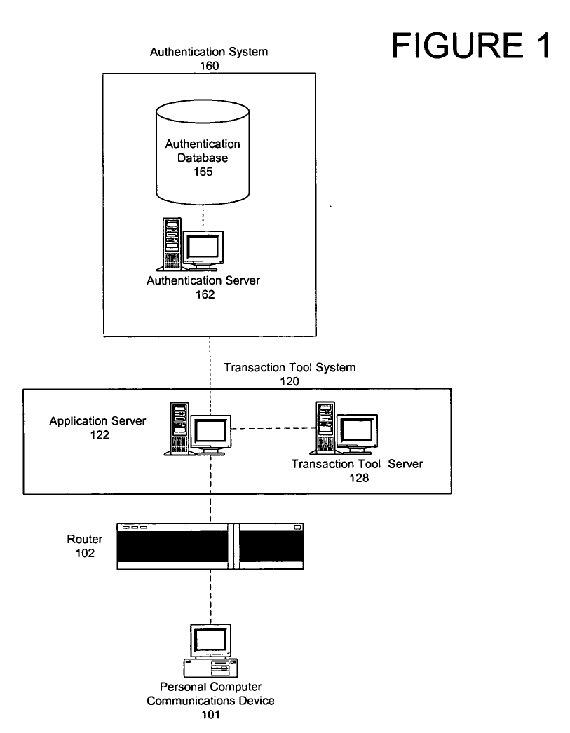

FIG. 1 shows an exemplary communications network architecture for pluggable authentication for transaction tool management services. As shown, a personal computer communications device 101 communicates through a router 102. The router 102 is part of a packet-switching network such as the internet. The router routes communications to a transaction tool system 120 that includes an application server 122 and a transaction tool server 128. The application server 122 may provide a web page or a web service to users over the packet-switching network for a transaction tool provider. The transaction tool server 128 performs back-end processing such as database management for a transaction tool provider. The transaction tool provider that provides the transaction tool system 120 may be a digital certificate issuer, a digital certificate escrow service, an online payment processing service or even a company's internal system that registers and manages transaction tools that are installed on the company's private or local network.

The transaction tool system 120 enables the user to request functions such as digital certificate registration, digital certificate revocation/cancellation, public key distribution or signature verification. Additionally, the transaction tool system 120 enables the user to request management of the transaction tool. However, the transaction tool system 120 may require different forms of authentication for one or more functions, particularly management functions.

To authenticate the identity of a user, the transaction tool system 120 may determine whether the user's personal computer 101 is a device to which a digital certificate has been issued for the user. The transaction tool system 120 may analyze the address (e.g., internet protocol address or telephone number/automatic number identifier) or general geographic location of the user's personal computer 101, to ensure that the user is communicating from an authorized location.

When the transaction tool system 120 determines that the user is requesting a particular management of the transaction tool, the transaction tool system 120 determines the types and methods of authentication that are required. Accordingly, the application server 122 may initiate a session with the authentication system 160 when external high-level authentication is needed. The authentication information is forwarded from the transaction tool system 120 to the authentication system 160 over a network such as the PSTN or the internet. In the case of voice recognition, the speech is already packetized when the speech samples are received from a router 102 over a packet-switched network. Exemplary pre-packaged voice recognition software implementations that may be used by an authentication system 160 for voice recognition are available from ScanSoft Inc. of Peabody, Mass. or from Nuance of Menlo Park, Calif.

If the authentication information from the user matches stored authentication information, the user is authenticated. Of course, the user must be pre-registered with the authentication system 160 for the authentication system 160 to provide an authentication service. Accordingly, the transaction tool system 120 may instruct the user to register with the authentication system 160 when the user first obtains a transaction tool that is managed by the transaction tool system 120.

The authentication server 162 may arrange to store information related to an authentication attempt in the authentication database 165. The authentication server 162 also generates information including call and authentication information that can then be used to support audit efforts. For example, the authentication server 162 may store information that indicates who the application server 122 expects to be identified, e.g., “User: Andrew Carnegie, <IP Address>” or Andrew Carnegie, account number 111-22-3333”. The authentication server 162 may also store information from the received authentication information to ensure that a record is kept of the authentication information provided by a user who requests to be authenticated. The information from the authentication server 162 is stored in the authentication database 165.

As an example, the transaction tool system 120 may be an escrow service that manages digital certificates for a digital certificate issuer. An exemplary digital certificate complies with ITU-T Recommendation X.509. A digital certificate is issued by a certification authority and is installed for a networked computer such as the personal computer communications device 101. The digital certificate is part of a public key infrastructure (PKI) that uses digital signatures to enhance the security and authenticity of communications between computers in a network.

Public key infrastructure uses key pairs of a private key and a public key. The digital certificate asserts that a certain public key is bound to a “subject” of the certificate, i.e., the entity to which the certificate is issued. The public key is made widely available by the subject of the certificate. The private key is held securely by the subject of the certificate. The public key and private key are mathematically related so that a message encrypted using the private key may be decrypted using the public key.

In the example where the transaction tool system 120 is an escrow service for the management of X.509 digital certificates, the transaction tool system 120 may be entrusted with storing a copy of the private key for the issuing certification authority. Additionally, the transaction tool system 120 may distribute its own public key to verify a digital signature on a digital certificate that serves as the certification authority's guarantee that the digital certificate and resulting encryption are bound to the user. Accordingly, when the escrow service receives a management request to recover public keys which it distributed, to revoke the digital certificate entirely, or to issue a new digital certificate, the escrow service uses the authentication system 160 to obtain a high-level authentication of the user's identity. For other functions, such as requests from the user to distribute the public key, the transaction tool system 120 may require only a product identification/password combination from the user.

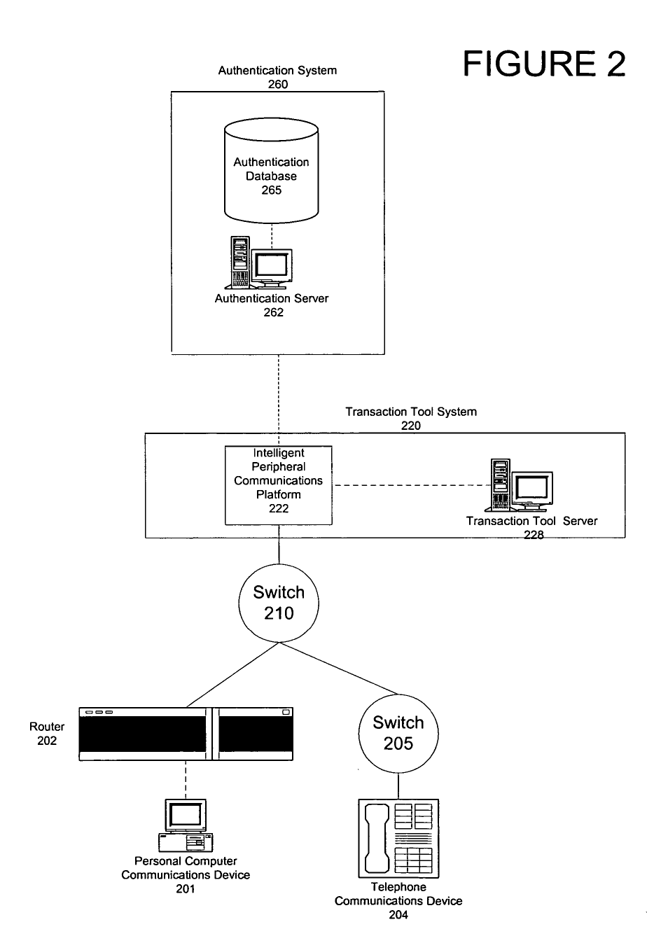

FIG. 2 shows another exemplary communications network architecture for pluggable authentication for transaction tool management services. As shown, an individual telephone communications device 204 is connected to a representative switch 205 of the public switched telephone network (PSTN). Of course, in an embodiment, the telephone may be a wireless telephone connected to the switch 205 via a cellular tower or other wireless receiver. In another embodiment, a personal computer communications device 201 communicates via a router 202 instead of the switch 205. The personal computer 201 and the telephone 204 are each connected to a switch 210 that is connected to an intelligent peripheral communications platform 222 in a transaction tool system 220.

The switch 205 and the switch 210 communicate with each other over a circuit-switched network. The switch 205 forwards the call to the switch 210 which, in turn, forwards the call to the intelligent peripheral communications platform 222. Of course, a single switch may serve as both the switch 205 and the switch 210 in a telecommunications network.

According to an aspect of the present invention, the router 202 routes packets according to a packet-switching protocol, e.g., transmission control protocol/internet protocol (TCP/IP). The router routes, e.g., voice over internet protocol (VOIP), packets over a packet-switching network to a network gateway (not shown) which depacketizes the packets and forwards them over a circuit-switched network to the switch 210. The switch 210 forwards a call that includes the resulting speech to the intelligent peripheral communications platform 222.

The intelligent peripheral communications platform 222 may be an interactive voice response device or another type of intelligent peripheral device provisioned with interactive voice response functionality. Exemplary interactive voice response devices include an IBM Resource Manager, a Lucent Compact Service Node or a Lucent Enhanced Media Resource Server (eMRS). Alternatively, the intelligent peripheral communications platform 222 may be a service node/intelligent peripheral that independently determines a sequence of instructions to forward to the user. The intelligent peripheral communications platform 222 plays messages to the user and receives input from the user via dual-tone multi frequency (DTMF) tones. When the intelligent peripheral communications platform 222 receives information that indicates that the user needs to be authenticated, the transaction tool platform 220 determines the authentication types and methods required for the requested function.

The transaction tool server 228 performs back-end processing such as database management for a transaction tool provider. For example, the transaction tool server 228 may provide application interfaces for the transaction tool provider's personnel to input, organize and retrieve data from a series of databases (not shown) used to store transaction tool information for customers and subscribers. The transaction tool server 228 may also organize and arrange storage for customer transaction information received after a transaction is conducted.

In an embodiment, the transaction tool platform 220 forwards authentication information from the transaction tool system 220 to an authentication system 260. The intelligent peripheral communications platform 222 and the authentication system 260 interact until the authentication system 260 determines whether the identity of the user can be established. The intelligent peripheral communications platform 222 may communicate with the authentication system 260 through a packet-switching network such as the internet. An exemplary authentication system that receives packetized authentication information is disclosed in U.S. patent application Ser. No. ______ (Attorney Docket No. P25366) “Voice over IP Based Biometric Authentication” to NOVACK et al., filed Jul. 30, 2004, the disclosure of which is expressly incorporated by reference herein in its entirety.

The authentication system 260 includes an authentication server 262 that processes the information from the transaction tool system 220. The information from the transaction tool system 220 may include an expected identity of the user, authentication information of the user, and any other information that would be useful to authenticate the user as desired by the transaction tool system 220.

Additionally, the authentication system 260 includes an authentication database 265 that stores pre-registered authentication information and/or identifying information for one or more individuals. The authentication server 262 retrieves the authentication information from the authentication database 265 and compares the retrieved authentication information with the authentication information received from the transaction tool system 220. The identity of the user is authenticated when it is determined that one or more characteristics of the authentication information bear adequate similarities to the authentication information from the authentication database 265.

Of course, many types of authentication may be performed by the intelligent peripheral communications platform 222. For example, for simple information requests, the intelligent peripheral communications platform 222 may request and analyze an account number, a product number and/or a personal identification number from the user. Additionally, the intelligent peripheral communications platform 222 may analyze an automatic number identifier (ANI) that is received over a circuit-switched network.

In any case, the transaction tool system 220 determines which authentication types and methods are necessary based upon the risk presented by the particular request. The greater the risk or liability faced by the transaction tool system, the greater then need for higher levels of authentication. As an example, the transaction tool system 220 may determine which authentication methods to require based upon the requested function, the purported requestor, the location of the user and/or the communications mode being used by the user.

As an example of the uses of the communications network architecture shown in FIG. 2, a credit card company may allow credit card users to activate or cancel a credit card, review transaction and payment history, and conduct transactions such as cash advances or balance transfers, by calling a service number corresponding to the intelligent peripheral communications platform 222. The intelligent peripheral communications platform 222 may be used as an interface to a transaction tool server 228 that processes information for the credit card company's customers. However, the credit card company may require heightened authentication of the user before processing a particular request for a life cycle change to the credit card account, such as activation or cancellation. Accordingly, when the call flow of the call to the intelligent peripheral communications platform 222 reaches the point where the user requests to change their account information, the intelligent peripheral communications platform 222 may initiate a session with the authentication system 260. For example, the intelligent peripheral communications platform 222 may contact the authentication system 260 to obtain authentication of the user's identity using voice recognition. Other functions such as requests to review recent activity may not require an external system; rather, the functionality may simply require account number/personal identification number combinations that can be verified by the intelligent peripheral communications platform 222.

Accordingly, the communications system of FIG. 2 enables pluggable authentication for transaction tool management services so that the functionality of multiple authentication methods may be used as necessary for a user communicating with the transaction tool system 220. The transaction tool system 220 may determine the authentication methods required depending on the risk factors presented for the particular request. For example, the transaction tool system 220 may calculate a score by assigning weights to predetermined criteria. Alternatively, the transaction tool system 220 may use a look-up table that matches the circumstances of the request to authentication methods required before the request can be honored. Accordingly, the authentication processes selected by the transaction tool system 220 may vary based upon the circumstances of the request.

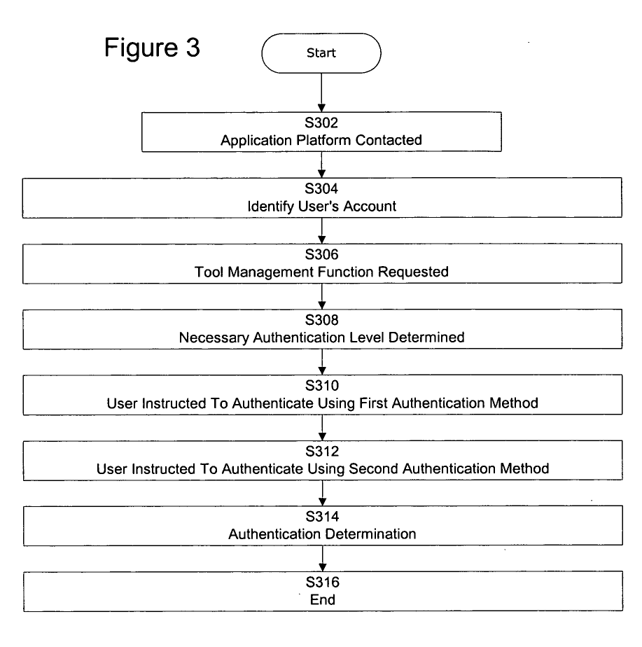

FIG. 3 shows an exemplary method of authenticating an individual with pluggable authentication for transaction tool management services. The process starts when the user contacts an application platform at S302 by, e.g., calling a number corresponding to an intelligent peripheral or typing the internet address of a web service into a web browser's address bar. At S304, the user's account information is identified. For example, the user may be requested to press the numbers of an account into a handset or to provide information into a form on the internet. At S306, the user requests a tool management function such as a life cycle change to the transaction tool. The transaction tool system 120, 220 determines the necessary authentication level and methods required for the function at S308. In this regard, the determination may include an analysis of the circumstances of the request so that a risk level for the request may be determined. In another embodiment, the authentication methods to be required for a particular management process are predetermined (i.e., static), so that a request for a particular management process always results in the same set of required authentications. Of course, the authentication methods required for different management processes may vary as the risk level varies.

The necessary authentication level may be determined based upon the requested function, the purported requester, the location of the user and/or the communications mode being used by the user. The methods of authentication may be implemented at the transaction tool system 120/220 or at an authentication system 160/260. As examples, the authentication methods may include obtaining and analyzing account numbers, passwords, birth dates or other information indicated knowledge of a user's background, biometrics including voice recognition or remote fingerprint scanning, or any other authentication information that can be implemented over a communications network.

At S310, the calling party is instructed to provide a first set of authentication information. For example, the calling party may be instructed to provide a pass code or to swipe a magnetic strip on a physical card corresponding to the transaction tool over a card reader. At S312, the calling party is instructed to provide a second set of authentication information. For example, the calling party may be instructed to repeat a phrase into a telephone handset so that the calling party may be authenticated by voice recognition. The transaction tool system 120, 220 may initiate a session with the authentication system 160, 260 for the authentication at S310 and/or S312. Of course, the user may not be made aware of the session with the authentication system 160, 260. At S314, an authentication determination is made and the process ends at S316.

The authentication system 160, 260 informs the transaction tool system 120, 220 of the authentication decision and the transaction tool system 120, 220 either enables or denies the requested function according to-the authentication decision. If the user is authenticated, the transaction tool system 120, 220 completes the interaction with the user as normal. If the user is not authenticated, the user may be instructed to contact a customer service representative. Accordingly, the transaction tool system 120, 220 ensures that confidential information or decision-making authority is not provided to an imposter.

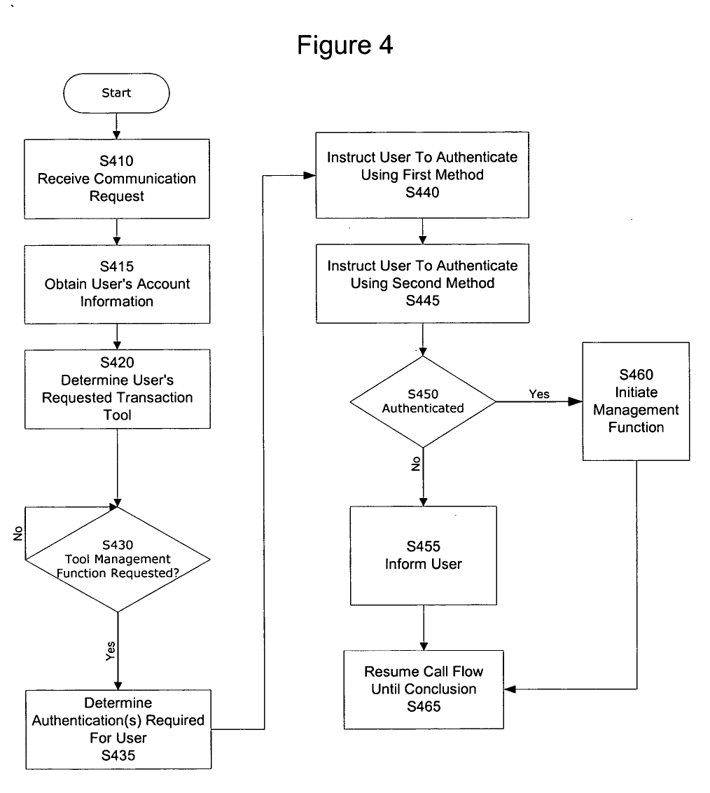

FIG. 4 shows an exemplary method of operation for a transaction tool system 120, 220 that uses pluggable authentication for transaction tool management services. After the process starts, a communications request is received at S410 when, e.g., a user dials a number on a telephone keypad or enters an internet address into a web browser. At S415, the transaction tool system 120, 220 obtains the user's account information. At S420, the transaction tool system 120, 220 determines which transaction tool is associated with the calling party according to the account information provided by the user.

At S430, the transaction tool system 120, 220 determines whether a tool management function is requested. The transaction tool system 120, 220 repeats the determination at S430 (S430=No) until a tool management function is requested. When a tool management function is requested (S430=Yes), the transaction tool system 120, 220 determines which authentications methods are required from the user at S435. In this example, two kinds of authentication are required, although one or more tool management functions may not require two authentication methods in other embodiments. In this regard, the determination at S435 is based upon the risk-factors presented by the requested function and the circumstances of the request. Accordingly, the number and types of authentication methods that are required varies based upon the risk presented by the user.

At S440, the user is instructed to authenticate his identity by a first method. At S445, the user is instructed to authenticate his identity by a second method. At S450, the transaction tool management system 120, 220 determines whether the user has been authenticated. If the user is successfully authenticated (S450=Yes), the requested management function is initiated at S460 and the call flow resumes until a conclusion at S465. If the user is not authenticated (S450=No), the user is informed that the requested management function cannot be performed at S455 and the call flow resumes until a conclusion at S465.

Of course, the steps shown in the figures may be performed in a different order, or not be performed at all. For example, S445 of FIG. 4 may involve contacting an authentication system 160, 260. Furthermore, the user may be identified and authenticated according to more than two methods, or using other existing or later-developed methods that are capable of identifying an individual over a communications network.

Accordingly, a communications system of the present invention enables pluggable authentication for transaction tool management services so that the functionality of multiple authentication methods may be used as necessary for a user communicating with a transaction tool system. The transaction tool system may determine the authentication methods required depending on the risk factors presented for the particular request. For example, the transaction tool system may calculate a score by assigning weights to predetermined criteria. Alternatively, the transaction tool system may use a look-up table that matches the circumstances of the request to authentication methods required before the request can be honored. Accordingly, the authentication methods selected by the transaction tool system may vary based upon the circumstances of the request.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims. For example, instead of voice recognition using voice over IP packetization, a intelligent peripheral communications platform 222 may packetize authentication information using multiprotocol label switching (MPLS) or any other standard for packet-switched communications.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. For example, each of the standards for digital certificate format (e.g., X.509) and packet switched network transmission (e.g., VOIP, MPLS) represent examples of the state of the art. Such standards are periodically superseded by faster or more efficient equivalents having essentially the same functions. Accordingly, replacement standards and protocols having the same functions are considered equivalents.

What is claimed is:

1. A system for managing a transaction tool for an individual, comprising:
a receiver that receives a request from the individual to initiate a process for managing the transaction tool; and
a processor that analyzes the request from the individual and dynamically selects, based upon the requested process, at least one authentication method to be used for authenticating the identity of the individual before the request can be honored, the selected at least one authentication method being used to verify the identity of the individual.

2. The pluggable authentication system of claim 1, in which the processor dynamically selects a plurality of authentication methods to be used.

3. The system of claim 1, in which the selected at least one authentication method is further based upon at least one of a type of location from which the request is received and a type of communications mode used to make the request.

4. The system of claim 1, in which the request is received over a network.

5. The system of claim 1, in which the requested process is one of a recovery, a revocation and an activation of a digital certificate.

6. The system of claim 1, in which the requested process is one of an activation and a cancellation of a credit account.

7. The system of claim 1, in which the at least one authentication method includes an authentication method performed by an external authentication service.

8. A method for managing a transaction tool for an individual, comprising:
receiving a request from the individual to initiate a process for managing the transaction tool;
analyzing the request from the individual and dynamically selecting, based upon the requested process, at least one authentication method to be used for authenticating the identity of the individual before the request can be honored; and
verifying the identity of the individual using the selected at least one authentication method.

9. The method for securely managing a transaction tool of claim 8, the dynamically selecting further comprising dynamically selecting a plurality of authentication methods to be used.

10. The method for securely managing transaction tools of claim 8, wherein the selected at least one authentication method is further based upon at least one of a type of location from which the request is received and a type of communications mode used to make the request.

11. The method for securely managing transaction tools of claim 8, wherein the request is received over a network.

12. The method for securely managing transaction tools of claim 8, wherein the requested process is one of a recovery, a revocation and an issuance of a digital certificate.

13. The method for securely managing transaction tools of claim 8, wherein the requested process is one of an activation and a cancellation of a credit account.

14. The method for securely managing transaction tools of claim 8, wherein the at least one authentication method includes an authentication method performed by an external authentication service.

15. A computer readable medium storing a program that manages a transaction tool for an individual, the computer readable medium comprising:
a request receiving code segment that receives a request from the individual to initiate a process for managing the transaction tool;
an analyzing code segment that analyzes the request from the individual and dynamically selects, based upon the requested process, at least one authentication method to be used for authenticating the identity of the individual before the request can be honored; and
a verifying source code segment that verifies the identity of the individual using the selected at least one authentication method.

16. The computer readable medium of claim 15, the analyzing code segment further dynamically selecting a plurality of authentication methods to be used.

17. The computer readable medium of claim 15, the analyzing code segment further selecting the at least one authentication method based upon at least one of a type of location from which the request is received and a type of communications mode used to make the request.

18. The computer readable medium of claim 15, the request receiving code segment receiving the request over a network.

19. The computer readable medium of claim 15, the request receiving code segment receiving a request to initiate a process comprising one of a recovery, a revocation and an issuance of a digital certificate.

20. The computer readable medium of claim 15, the request receiving code segment receiving a request to initiate a process comprising one of an activation and a cancellation of a credit account.

21. The computer readable medium of claim 15, wherein the at least one authentication method includes an authentication method performed by an external authentication service.
